(19) United States
(12) Patent Application Publication
(10) Pub. No.: US 2006/0145941 A1
(43) Pub. Date: Jul. 6, 2006

(54) Display system and host device for outputing image signal and method therefor

(75) Inventors: Dong-sik Park, Suwon-si (KR); Young-chan Kim, Uiwang-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/280,337

(22) Filed: Nov. 17, 2005

(30) Foreign Application Priority Data
Jan. 5, 2005 (KR) 2005-0000744

(51) Int. Cl. G09G 5/00

(52) U.S. Cl. 345/1.1

(57) ABSTRACT

A display system and method are provided in which a plurality of display devices have information about time for processing an image signal related thereto. A host device receives the information about the time for processing the image signal from the respective display devices, and delays the image signal output to at least one of the display devices on the basis of the time for processing the image signal. Accordingly, in a display system, a host device outputs an image signal to respective display devices while taking into account the time for processing the image signal in the respective display devices.

### CROSS-REFERENCE TO RELATED APPLICATIONS

This application claims benefit under 35 U.S.C. §119 from Korean Patent Application No. 2005-0000744, filed on Jan. 5, 2005, in the Korean Intellectual Property Office, the entire disclosure of which is hereby incorporated by reference.

### BACKGROUND OF THE INVENTION

1. Field of the Invention

The present invention relates to a display system and a host device. More particularly, the present invention relates to a display system and a host device in which a host device outputs an image signal to a plurality of display devices, and to a method for outputting an image signal to a plurality of display devices.

2. Description of the Related Art

A conventional multi screen display system has an arrangement where several display devices are adjacent to each other and form a single large screen. That is, the multi screen display system allows the display devices to display a portion of an image respectively, thereby forming a single image. Such a multi screen device is mainly used, for example, in a convention or exhibit hall, and the like, requiring a large screen.

It is important to synchronize each image signal processed in the respective display devices in that the display system forms a single integrated image by connecting an individual image displayed on a plurality of display devices.

If there is time difference in processing the image signal input to the respective display devices to display the image, the integrated image may be deteriorated, cut off, and the like, even though the image signal output from the host device to the respective display devices is synchronized.

To address the foregoing problem, the host device may output the image signal to the respective display devices taking into consideration the time for processing of the image signal in the respective display devices.

### SUMMARY OF THE INVENTION

Accordingly, an exemplary aspect of the present invention is to provide a display system and a host device in which a host device outputs an image signal to respective display devices taking into consideration the time for processing of the image signal in the respective display devices.

Additional exemplary aspects and/or advantages of the present invention will be set forth in part in the description which follows and, in part, will be understood by those skilled in the art from the following description.

According to an exemplary implementation of the present invention, a display system comprises a plurality of display devices comprising information about time for processing an image signal, and a host device receiving the information about the time for processing the image signal from the respective display devices, delaying the image signal output to at least one of the display devices on the basis of the time for processing the image signal and outputting the image signal.

According to an exemplary aspect of the present invention, the respective display devices comprise a display memory storing the information about the time for processing the image signal, and a display interface transmitting the information about the time for processing the image signal stored in the display memory to the host device.

According to an exemplary aspect of the present invention, the host device comprises a host interface connected with the display interface, a signal delayer delaying the image signal output to the respective display devices, and a host controller controlling the signal delayer to delay the image signal output to at least one of the plurality of display devices according to a delaying time of the image signal of the display devices received through the host interface.

According to an exemplary aspect of the present invention, the display interface and the host interface are connected with each other either through a display data channel interface or through an universal serial bus interface.

According to an exemplary aspect of the present invention, the host device and the respective display devices support a digital packet video link (DPVL) standard of the video electronics standards association, and the host device outputs the image signal to the respective display devices through the digital packet video link standard.

According to an exemplary aspect of the present invention, the information about the delay time of the image signal is recorded in a predetermined address of digital packet video link extension block (DPVL-EXT) information supplied from the respective display devices to the host device.

According to an exemplary aspect of the present invention, the host device outputs a divided image signal to the respective display devices to form a single integrated image.

According to an exemplary aspect of the present invention, the display devices comprise a first display device directly connected to the host device, and a second display device connected with the host device through the first display device.

According to an exemplary aspect of the present invention, the display system further comprises a DPVL hub connected either to the host device or to the display device, and the display devices comprise a third display device connected with the host device through the DPVL hub.

According to an aspect of the present invention, the information about the time for processing the image signal comprises connection information of the respective display devices.

The foregoing and/or other exemplary aspects of the present invention may also be achieved by providing, for example, a host device available for outputting an image signal to a plurality of display devices, comprising a host interface receiving information about a delaying time of the image signal supplied from the respective display devices, a signal delayer delaying the image signal output to the respective display devices, and a host controller controlling the signal delayer to delay the image signal output to at least one of the display devices according to the delaying time of the image signal of the respective display devices which is received from the host interface.

According to an exemplary aspect of the present invention, the host controller outputs the image signal to the respective display devices through a digital packet video link standard of the video electronics standards association.

According to an exemplary aspect of the present invention, the host interface is connected with the respective display devices either through a display data channel interface or through an universal serial bus interface.

According to an exemplary aspect of the present invention, the information about the relaying time of the image signal is recorded in a predetermined address of DPVL-EXT (DPVL extension block) information supplied from the respective display devices.

### BRIEF DESCRIPTION OF THE DRAWINGS

The above and/or other exemplary aspects and advantages of the present invention will become more apparent and more readily appreciated from the following description of the exemplary embodiments of the present invention, taken in conjunction with the accompanying drawings in which like reference symbols indicate the same or similar components, wherein:

FIG. 1 illustrates a configuration of a display system according to a first embodiment of the present invention;

FIG. 2 is a control block diagram of a display device in FIG. 1;

FIG. 3 is a control block diagram of a host device in FIG. 1;

FIG. 4 illustrates a configuration of a display system according to a second embodiment of the present invention; and

FIG. 5 illustrates an example of an image displayed on a display device according to the second embodiment of the present invention.

### DETAILED DESCRIPTION OF EXAMPLARY EMBODIMENTS

Reference will now be made in detail to the embodiments of the present invention, examples of which are illustrated in the accompanying drawings, wherein, as noted above, like reference numerals refer to like elements throughout.

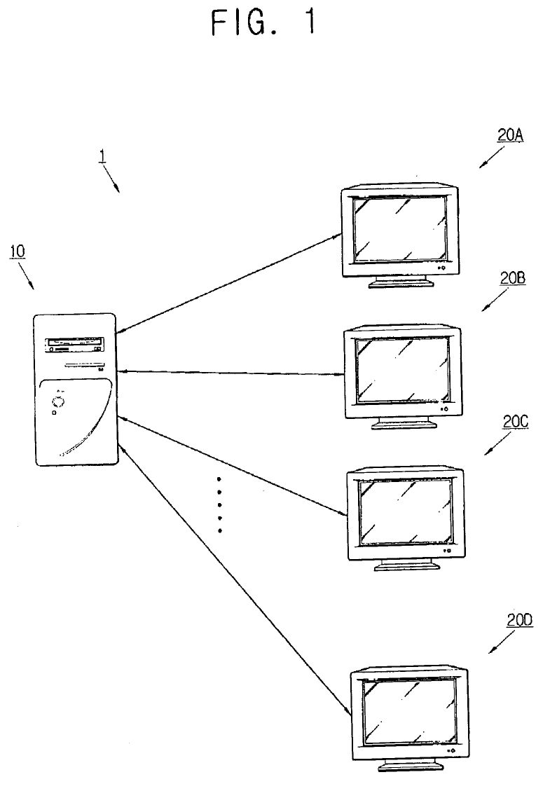

As shown in FIG. 1, a display system 1 according to an exemplary embodiment of the present invention comprises a host device 10, and a plurality of display devices 20A, 20B, 20C and 20D connected to the host device 10.

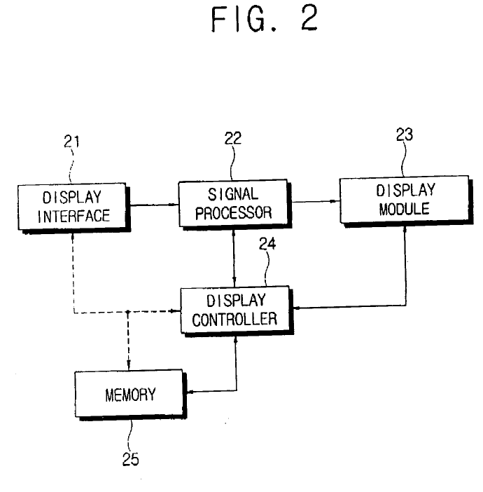

As shown in FIG. 2, the respective display devices 20A, 20B, 20C and 20D may comprise a display interface 21, a signal processor 22, a display module 23, a memory 25 and a display controller 24.

The memory 25 stores information about time for processing an image signal. According to an exemplary implementation of the present invention, the time for processing the image signal comprises time for displaying the input image signal on the display module 23 by the respective display devices 20A, 20B, 20C and 20D. For example, the time for processing the image signal may reflect processing speed of a frame buffer provided in the signal processor 22, and/or time for executing image improvement algorithm provided in the signal processor 22 to improve picture quality, color, and the like of the image displayed on the display module 23. If the display module 23 according to an exemplary implementation of the present invention employs a liquid crystal display (LCD) panel, the time for processing the image signal may reflect a pattern display on-time of the LCD panel.

The display module 23 processes the signal input from the signal processor 22 and displays it on a screen as an image. According to an exemplary implementation of the present invention, the display module 23 may comprise a display panel displaying the image thereon, and a panel driver controlling the display panel to display the image thereon according to a signal input from the signal processor 22. The display module 23 according to an exemplary embodiments of the present invention may employ various kinds of display modules such as a digital light processing (DLP), a liquid crystal display (LCD), a plasma display panel (PDP), and the like.

The signal processor 22 converts the image signal input through the display interface 21 to be processed by the display module 23. The signal processor 22 according to an exemplary embodiment of the present invention may be provided in various forms according to a format of the image signal input thereto.

The display interface 21 is connected to the host device 10 and receives the image signal output from the host device 10. Also, the display interface 21 supports a two-way communication channel communicating with the host device 10. The display interface 21 according to an exemplary implementation of the present invention may support at least one of a display data channel (DDC) interface or an universal serial bus (USB) interface. According to an exemplary implementation of the present invention, the display devices 20A, 20B, 20C and 20D provide the host device 10 with the information about the time for processing the image signal stored in the memory 25 through the DDC interface or the USB interface.

The display controller 24 controls the signal processor 22 and/or the display module 23 to display the image signal input through the display interface 21 on the display module 23 as an image.

In an exemplary implementation, display system 1 according to an embodiment of the present invention comprises four display devices 20A, 20B, 20C and 20D. The four display devices may be defined as a first display device 20A, a second display device 20B, a third display device 20C and a fourth display device 20D, respectively.

The host device 10 receives from display devices 20A, 20B, 20C and 20D the information about image signal processing time of the respective display devices 20A, 20B, 20C and 20D. The host device 10 delays the image signal output to at least one of the respective display devices 20A, 20B, 20C and 20D for a predetermined time and outputs the image signal on the basis of the information about the time for processing the image signal supplied from the respective display devices 20A, 20B, 20C and 20D.

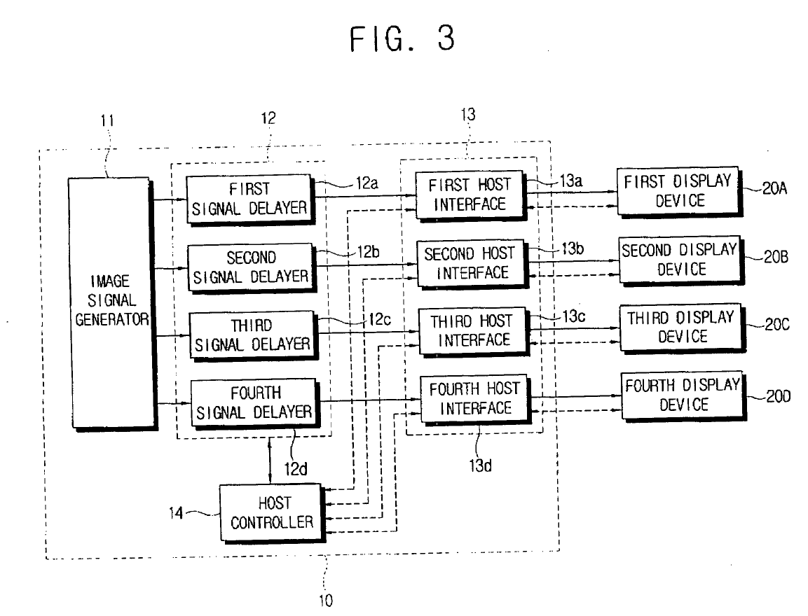

As shown in FIG. 3, the host device 10 according to an embodiment of the present invention may comprise an image signal generator 11, a signal delayer 12, a host interface 13 and a host controller 14.

The image signal generator 11 generates the image signal output to the respective display devices 20A, 20B, 20C and 20D. For example, if the host device according to an embodiment of the present invention is as a computer, the image signal generator 11 may comprise a graphics adapter, an application program to supply image data in a predetermined format with the graphics adapter, an operation system connecting the graphics adapter and the application program, and the like.

According to an exemplary implementation of the present invention, the image signal generator 11 may output an identical image signal to the respective display devices 20A, 20B, 20C and 20D. Also, the image signal generator 11 may output the image signal divided from the image signal corresponding to the single screen to the display devices 20A, 20B, 20C and 20D to form the image displayed on the display devices 20A, 20B, 20C and 20D as the single integrated image.

The signal delayer 12 delays the image signal output from the image signal generator 11 to the respective display devices 20A, 20B, 20C and 20D for a predetermined time, and outputs it to the host interface 13 connected with the respective display devices 20A, 20B, 20C and 20D. According to an exemplary implementation of the present invention, the signal delayer 12 may comprise a first signal delayer 12a for delaying the image signal output to the first display device 20A, a second signal delayer 12b for delaying the image signal output to the second display device 20B, a third signal delayer 12c for delaying the image signal output to the third display device 20C and a fourth signal delayer 12d for delaying the image signal output to the fourth display device 20D.

The host interface 13 is connected with the respective display interface 21. According to an exemplary implementation of the present invention, the host interface 13 outputs the image signal from the signal delayer 12 to the respective display devices 20A, 20B, 20C and 20D. The host interface 13 may comprise a first host interface 13a, a second host interface 13b, a third host interface 13c and a fourth host interface 13d respectively connected with the first display device 20A, the second display device 20B, the third display device 20C and the fourth display device 20D. The respective host interface 13 may be provided as an extra connector or two host interfaces 13 may be provided as a single connector.

According to an exemplary implementation of the present invention, the host interface 13 receives the information about the time for processing the image signal supplied from the respective display devices 20A, 20B, 20C and 20D. The information about the time for processing the image signal received via the host interface 13 is input to the host controller 14.

The host interface 13 supports an interface corresponding to the display interface 21. For example, if the display interface 21 supports the DDC interface, the host interface 13 supports the DDC interface corresponding thereto. Conversely, if the display interface 21 supports the USB interface, the host interface 13 supports the USB interface corresponding thereto.

The host controller 14 controls the signal delayer 12 to delay the image signal output to at least one of the respective display devices 20A, 20B, 20C and 20D on the basis of the information about the time for processing the image signal of the respective display devices 20A, 20B, 20C and 20D supplied from the host interface 13.

For example, if it is determined that the time for processing the image signal of the first display device 20A is 10 ns, those of the second display device 20B and the third display device 20C are 8 ns, and that of the fourth display device 20D is 6 ns, the host controller 14 then controls the second signal delayer 12b and the third signal delayer 12c to delay the image signal output to the second display device 20B and the third display device 20C by 2 ns, and controls the fourth signal delayer 12d to delay the image signal output to the fourth display device 20D by 4 ns. Accordingly, when the respective display devices 20A, 20B, 20C and 20D process the image signal input from the host device 10 and display the image on the display module 23, the images displayed on the respective display devices 20A, 20B, 20C and 20D are synchronized.

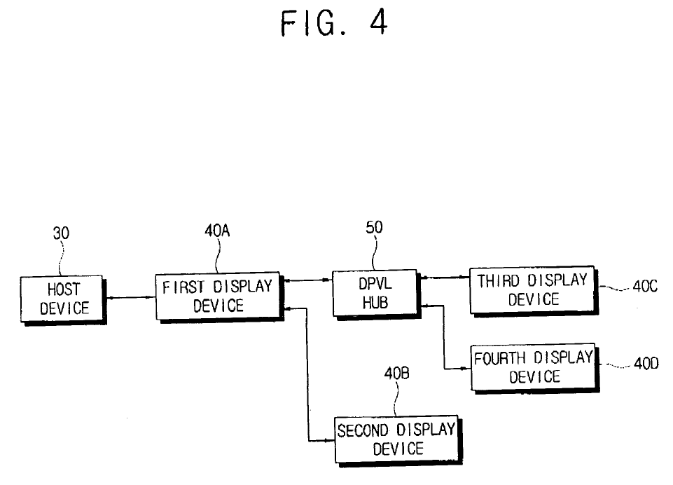

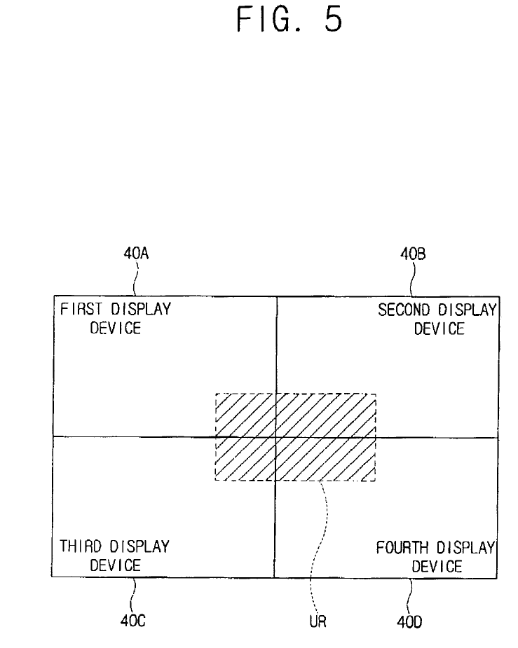

A display system 3 according to another embodiment of the present invention is described with reference to FIGS. 4 and 5 as follows.

In a display system 3 according to an embodiment of the present invention, a host device 30 and display devices 40A, 40B, 40C and 40D may support standards of a digital packet video link (DPVL) of the video electronics standards association (VESA).

Accordingly, the host device 30 may output an image signal by packet corresponding to the DPVL standards to the respective display devices 40A, 40B, 40C and 40D.

According to an exemplary implementation of the present invention, the information about the time for processing the image signal may be recorded in a predetermined address of a DPVL extension block (DPVL-EXT) of the VESA. If the respective display devices 40A, 40B, 40C and 40D transmit the DPVL-EXT to the host device 30, a display controller 24 of the display devices 40A, 40B, 40C and 40D may read out the information about time for delaying the image signal from the appropriate address of the DPVL-EXT.

According to an exemplary implementation of the present invention, the display system 3 according to an embodiment of the present invention may comprise the first display device 40A directly connected to the host device 30; and the second display device 40B connected with the host device 30 via the first display device 40A.

According to an exemplary implementation of the present invention, the display system 3 may further comprise a DPVL hub connected with the host device 30. The third display device 40C and the fourth display device 40D are connected with the host device 30 through the DPVL hub 50.

According to an exemplary implementation of the present invention, the information about the time for processing the image signal supplied from the respective display devices 40A, 40B, 40C and 40D to the host device 30 may comprise the connection relation between the respective display devices 40A, 40B, 40C and 40D, and the host device 30 as shown in FIG. 4.

For example, the time for displaying the image on the first display device 40A directly connected with the host device 30 is less than that for displaying the image on the third display device 40C and the fourth display device 40D connected with the host device 30 through the DPVL hub 50, when taking into consideration a transmitting path of the image signal, the time for processing the image signal in the DPVL hub 50, and the like. Thus, the information about the time for processing the image signal reflects the connection relation between the host device 30, the display devices and/or the DPVL hub 50.

FIG. 5 illustrates an example of the image displayed on the display devices 40A, 40B, 40C and 40D according to the second embodiment of the present invention. As shown therein, even if an update rectangle (UR) according to the DPVL standards output from the host device 30 to the respective display devices 40A, 40B, 40C and 40D covers the respective display devices 40A, 40B, 40C and 40D, the host device 30 outputs the image signal reflecting time for displaying the image on the respective display devices 40A, 40B, 40C and 40D, i.e. the DPVL packet to the display devices 40A, 40B, 40C and 40D, thereby synchronizing the image displayed thereon.

, the internal configuration of the host device 30 and the display devices 40A, 40B, 40C and 40D of the display system 3 according to a second embodiment of the present invention may correspond to the display system 1 according to embodiment of the present invention. As the image signal transmission and communication between the host device 30 and the display devices 40A, 40B, 40C and 40D according to the DPVL standards are disclosed in the VESA digital packet video link standard of version 1 dated Apr. 18, 2004, the entire contents of which is hereby incorporated by reference, such transmission and communication need not be described further herein.

FIG. 4 illustrates an example of the connection relation of the display system 3 according to the DPVL standards. Further, the host device 30 may be directly connected with the respective display devices 40A, 40B, 40C and 40D as shown in FIG. 1, and the DPVL hub 50 may be directly connected with the host device 30. Also, the display system 3 according to the second embodiment of the present invention may comprise various other relations between the components in keeping with the principles outlined above.

While exemplary embodiments of the present invention have been shown and described, it will be appreciated by those skilled in the art that various changes and modifications may be made therein without departing from the principles and spirit of the invention, the scope of which is defined in the appended claims and their equivalents.

What is claimed is:

1. A display system comprising:
a first display device;
a second display device, wherein at least one of the first and second display devices comprises information about time for image signal processing related to the at least one of the first and second display devices; and
a host device for receiving the information about the time for the image signal processing related to the at least one of the first and second display devices, and delaying an image signal output to the at least one of the first and second display devices on the basis of the information about the time for the image signal processing related to the at least one of the first and second display devices.

2. The display system according to claim 1, wherein at least one of the first and second display devices comprises:
a display memory storing the information about the time for the image signal processing related to the at least one of the first and second display device; and
a display interface transmitting the information about the time for the image signal processing stored in the display memory to the host device.

3. The display system according to claim 2, wherein the host device comprises:
a host interface connected with the display interface;
a signal delayer delaying the image signal output to the at least one of the first and second display devices; and
a host controller controlling the signal delayer to delay the image signal output to the at least one of the first and second display devices according to the information about the time for the image signal processing related to the at least one of the first and second display devices received through the host interface.

4. The display system according to claim 3, wherein a connection between the display interface and the host interface comprises at least one of a display data channel interface and a universal serial bus interface.

5. The display system according to claim 3, wherein:
the host device and the at least one of the first and second display devices support a digital packet video link (DPLV) standard of the video electronics standards association; and
the host device outputs the image signal to the at least one of the fist and second display devices through the DPLV standard.

6. The display system according to claim 5, wherein the at least one of the first and second display devices supplies to the host device a digital packet video link extension block (DPVL-EXT) information comprising the information about the time for the image signal processing related to the at least one of the first and second display devices.

7. The display system according to claim 6, wherein the host device outputs a divided image signal to the first and second display devices, respectively, to form a single integrated image.

8. The display system according to claim 7, wherein the first display device connected comprises a direct connection with the host device; and the second display device comprises a connection with the host device through the first display device.

9. The display system according to claim 8, further comprising:
a DPVL hub connected to at least one of the host device, the first display device and the second display device, and
a third display device connected with the host device through the DPVL hub.

10. The display system according to claim 8, wherein the information about the time for the image signal processing related to the at least one of the first and second display devices comprises information related to the connection of the at least one of the fist and second display devices.

11. The display system according to claim 9, wherein the information about the time for the image signal processing related to the at least one of the first and second display devices comprises information related to the connection of the at least one of the fist and second display devices.

12. A host device for outputting an image signal to a plurality of display devices, the host device comprising:
a host interface receiving information about a delay time of an image signal supplied from at least one of a plurality of display devices;
a signal delayer delaying the image signal output to the at least one of the plurality of the display devices; and
a host controller controlling the signal delayer to delay the image signal output to the at least one of the plurality of the display devices according to the delay time of the image signal of the at least one of the plurality of the display devices.

13. The host device according to claim 12, wherein the host controller outputs the image signal to the at least one of the plurality of the display devices through a digital packet video link (DPVL) standard of the video electronics standards association.

14. The host device according to claim 13, wherein a connection between the host interface and the at least one of the plurality of the display devices comprises at least one of a display data channel interface and a universal serial bus interface.

15. The host device according to claim 14, wherein the at least one of the plurality of the display devices supplies to the host device a digital packet video link extension block (DPVL-EXT) information comprising the information about the delay time of the image signal of the at least one of the plurality of the display devices.

16. A method for displaying images on a display system comprising a plurality of display devices, the method comprising:
supplying information about a time for image signal processing related to at least one of a plurality of display device;
receiving the information about the time for the image signal processing related to the at least one of the plurality of the display devices; and
delaying an image signal output to the at least one of the plurality of the display devices on the basis of the information about the time for the image signal processing related to the at least one of the first and second display devices.

17. The method according to claim 16, further comprising outputting the image signal to the at least one of the plurality of the display devices through a digital packet video link (DPVL) standard.

18. The method according to claim 17, further comprising supplying a digital packet video link extension block (DPVL-EXT) information comprising the information about the time for the image signal processing related to the at least one of the plurality of the display devices.

19. The method according to claim 18, further comprising storing the information about the time for the image signal processing related to the at least one of the plurality of the display devices in a predetermined address of the DPVL-EXT.

20. The method according to claim 16, further comprising outputting a divided image signal to the plurality of the display devices, respectively, to form a single integrated image.
